(19) United States
(12) Patent Application Publication
(10) Pub. No.: US 2019/0068081 A1
(43) Pub. Date: Feb. 28, 2019

(54) CONVERTER

(71) Applicant: GENERAL ELECTRIC TECHNOLOGY GMBH, Baden (CH)

(72) Inventors: David Reginald TRAINER, Derby, Derbyshire (GB); Francisco Javier CHIVITE-ZABALZA, Stafford, Staffordshire (GB); Konstantin VERSHININ, Stafford, Staffordshire (GB); Robert WHITEHOUSE, Walton on the Hill, Staffordshire (GB); Jonathan Christopher NICHOLLS, Derby, Derbyshire (GB)

(21) Appl. No.: 16/077,258

(22) PCT Filed: Feb. 9, 2017
(86) PCT No.: PCT/EP2017/052904

§ 371 Date: Aug. 10, 2018

(30) Foreign Application Priority Data
Feb. 12, 2016 (GB) 1602553.8

(51) Int. Cl. H02M 7/487; H02M 1/32; H02M 7/757; H02M 7/5387

(52) U.S. Cl. CPC H02M 7/487; H02M 1/32; H02M 2007/4835; H02M 7/5387; H02M 7/7575

(57) ABSTRACT

A converter includes first and second DC terminals for connection to a DC network, limb(s) connected between the first and second DC terminals, and a controller. Each limb includes a phase element and DC side sub-converter(s). The phase element has switching elements and AC terminal(s) for connection to an AC network, the switching elements being switchable to selectively interconnect a DC side voltage at a DC side of the phase element and an AC side voltage at an AC side of the phase element, The DC side sub-converter(s) connected to the DC side of the phase element. The controller selectively controls the switching elements and the operation of each DC side sub-converter as a voltage synthesiser. The controller also controls the switching elements to provide a blocking voltage to limit or block the flow of a fault current between the AC and DC networks and through each limb.

### BACKGROUND OF THE INVENTION

Embodiments of the invention relate to a converter.

In high voltage direct current (HVDC) power transmission networks alternating current (AC) power is typically converted to direct current (DC) power for transmission via overhead lines, under-sea cables and/or underground cables. This conversion removes the need to compensate for the AC capacitive load effects imposed by the power transmission medium, i.e. the transmission line or cable, and reduces the cost per kilometre of the lines and/or cables, and thus becomes cost-effective when power needs to be transmitted over a long distance.

The conversion between DC power and AC power is utilized in power transmission networks where it is necessary to interconnect the DC and AC networks. In any such power transmission network, converters are required at each interface between AC and DC power to effect the required conversion; AC to DC or DC to AC.

### BRIEF DESCRIPTION OF THE INVENTION

According to an aspect of the invention, there is provided a converter comprising first and second DC terminals for connection to a DC network, the converter further including at least one limb connected between the first and second DC terminals, the or each limb including:

a phase element having a plurality of switching elements and at least one AC terminal for connection to an AC network, the plurality of switching elements configured to be switchable to selectively interconnect a DC side voltage at a DC side of the phase element and an AC side voltage at an AC side of the phase element, each switching element of the phase element configured to have forward and reverse voltage blocking capabilities; and

at least one DC side sub-converter connected to the DC side of the phase element, the or each DC side sub-converter configured to be operable as a voltage synthesiser,

wherein the converter further includes a controller configured to selectively control the switching of the switching elements of the phase element of the or each limb and configured to selectively control the operation of the or each DC side sub-converter of the or each limb as a voltage synthesiser, and

wherein the controller is configured to control the switching of the switching elements of the phase element of the or each limb to provide a blocking voltage to limit or block the flow of a fault current between the AC and DC networks and through the or each limb.

The normal operation of the converter of embodiments of the invention involves the switching of the switching elements and the operation of the or each DC side sub-converter as a voltage synthesiser to facilitate the transfer of power between the AC and DC networks.

It is desirable to optimise the design of the converter in order to provide size, weight and cost savings while providing the converter with reliable fault blocking and ride through capabilities. One way of optimising the design of the converter is by minimising the amount of components in the converter and the amount of external hardware associated with the converter.

An occurrence of a fault associated with the converter may lead to the flow of a fault current between the AC and DC networks and through the or each limb. Such a fault may be, but is not limited to, a short-circuit fault across the DC terminals, such as a pole-to-pole DC fault in the DC network.

The inclusion of the switching elements with forward and reverse voltage blocking capabilities and the configuration of the controller in the converter of embodiments of the invention enables the provision of the or each blocking voltage so as to limit or block the flow of a fault current between the AC and DC networks and through the or each limb. In other words, the provision of the voltage required to limit or block the flow of the fault current is shared between the switching elements. Although the inclusion of the switching elements with forward and reverse voltage blocking capabilities may result in increases in the size, weight and cost of the converter, such increases are significantly smaller than corresponding increases arising from the inclusion of external fault current reduction hardware such as circuit breakers.

The or each blocking voltage may be configured to oppose an AC driving voltage at the AC side of the or each phase element so as to limit or block the flow of the fault current between the AC and DC networks and through the or each limb. This provides a reliable means of limiting or blocking the fault current in circumstances where the flow of the fault current between the AC and DC networks and through the or each limb is driven by an AC driving voltage at the AC side of the or each phase element.

In an embodiment of the invention, the controller may be configured to coordinate: the switching of the switching elements of the phase element of the or each limb to provide a blocking voltage; and the operation of the DC side sub-converter or at least one of the DC side sub-converters of the or each limb to provide a synthesised voltage, so that the combination of the blocking and synthesised voltages are configured to limit or block the flow of a fault current between the AC and DC networks and through the or each limb.

Another way of optimising the design of the converter is by designing the voltage synthesising capability of the or each DC side sub-converter so as to minimise the excess voltage synthesising capability of the or each DC side sub-converter (it may be the case that a small amount of excess voltage synthesising capability may be required for safety and redundancy reasons). For example, the voltage synthesising capability of the or each DC side sub-converter may be designed to correspond to the normal operating voltage requirements of the AC and DC networks.

In response to the occurrence of the fault, the or each DC side sub-converter may be operated to provide a synthesised voltage so as to limit or block the flow of the fault current between the AC and DC networks and through the or each limb. However, the voltage required to be synthesised by the or each DC side sub-converter to limit or block the flow of the fault current is usually higher than the voltage synthesising capability of the or each DC side sub-converter that is designed to correspond to the normal operating voltage requirements of the AC and DC networks. Under such circumstances, the synthesised voltage would be insufficient to limit or block the flow of the fault current. Thus, in order to provide a synthesised voltage that is sufficiently large to limit or block the flow of the fault current, it would be necessary to increase the voltage synthesising capability of the or each DC side sub-converter, thus resulting in a sub-optimal converter design in terms of size, weight and cost.

The inclusion of the switching elements with forward and reverse voltage blocking capabilities and the configuration of the controller in the converter of embodiments of the invention enables the provision of the combination of the blocking and synthesised voltages so as to limit or block the flow of a fault current between the AC and DC networks and through the or each limb. In other words, the provision of the voltage required to limit or block the flow of the fault current is shared between the switching elements and the or each DC side sub-converter. This in turn allows the voltage synthesising capability of the or each DC side sub-converter to be designed so as to minimise the excess voltage synthesising capability of the or each DC side sub-converter for a more optimal converter design. Although the inclusion of the switching elements with forward and reverse voltage blocking capabilities may result in increases in the size, weight and cost of the converter, such increases are significantly smaller than the corresponding increases arising from increasing the voltage synthesising capability of the or each DC side sub-converter.

The configuration of the converter of embodiments of the invention therefore results in a converter with reliable fault blocking and ride through capabilities while allowing the converter to be based on a more optimal converter design in terms of size, weight and cost.

The combination of the blocking and synthesised voltages may be configured to oppose an AC driving voltage at the AC side of the or each phase element so as to limit or block the flow of the fault current between the AC and DC networks and through the or each limb. This provides a reliable means of limiting or blocking the fault current in circumstances where the flow of the fault current between the AC and DC networks and through the or each limb is driven by an AC driving voltage at the AC side of the or each phase element.

The configuration of the or each DC side sub-converter may vary in order for it to be capable of being operable as a voltage synthesiser

The or each DC side sub-converter may include at least one module. The or each module may include a plurality of module switches connected with at least one energy storage device. The plurality of module switches and the or each energy storage device in the or each module may be arranged to be combinable to selectively provide a voltage source.

The or each energy storage device may be any device that is capable of storing and releasing energy to provide a voltage, e.g. a capacitor, fuel cell or battery.

The or each DC side sub-converter may include a plurality of series-connected modules arranged to define a chain-link converter.

The structure of the chain-link converter permits build-up of a combined voltage across the chain-link converter, which is higher than the voltage available from each of its individual modules, each providing its own voltage, into the chain-link converter. In this manner switching of the module switches in each module causes the chain-link converter to provide a stepped variable voltage source, which permits the generation of a voltage waveform across the chain-link converter using a stepped approximation. As such the chain-link converter is capable of providing a wide range of complex voltage waveforms.

The or each DC side sub-converter of the or each limb may include at least one module connected between the first and second DC terminals, the or each module may include a plurality of module switches connected with at least one energy storage device, the plurality of module switches and the or each energy storage device in the or each module may be arranged to be combinable to selectively provide a voltage source, and the controller may be configured to control the switching of the module switches of the or each module connected between the first and second DC terminals so as to configure the or each module connected between the first and second DC terminals to form a short-circuit or open-circuit between the first and second DC terminals.

Such formation of the short-circuit or open-circuit between the first and second DC terminals prevents the or each energy storage device of the or each module connected between the first and second DC terminals from discharging into a DC fault that causes a zero DC voltage to appear across the first and second DC terminals.

In embodiments of the invention employing the use of the or each module, the controller may be configured to control the switching of the module switches of the or each module to selectively insert the or each corresponding capacitor into the converter so as to absorb inductive energy stored in DC side inductance on the DC side of the or each phase element. The configuration of the controller in this manner not only speeds up the decay time of a current arising from the stored inductive energy, but also removes the need for separate, additional hardware to absorb the inductive energy.

In further embodiments of the invention, the controller may be configured to control the hard or soft current switching of the switching elements of the or each phase element to provide the blocking voltage.

The choice of the switching elements undergoing hard or soft current switching when providing the blocking voltage depends on the design of the switching elements.

Hard switching the switching elements at a high over-current level permits a faster response time for providing the blocking voltage and thereby reduces the time to reach a current zero. The hard current switching however results in a high rate of change in current and thereby produces inductive energy, which may require the switching elements to be designed to be capable of absorbing or dissipating the inductive energy.

On the other hand soft switching the switching elements at a lower over-current level not only reduces the amount of inductive energy produced, but also results in a lower rate of change in current and thereby reduces the associated voltage transient. The soft current switching however results in a slower response time for providing the blocking voltage and thereby increases the time to reach a current zero.

Optionally the converter of embodiments of the invention may include a plurality of limbs, the phase element of each limb being connectable via the or each corresponding AC terminal to a respective phase of a multi-phase AC network. Further optionally the plurality of limbs may be connected in series between the first and second DC terminals.

In embodiments of the invention employing the use of the plurality of limbs, the controller may be configured to control the switching of the switching elements of the phase elements to provide the respective blocking voltages at the same time or in a staggered order. The choice of providing the respective blocking voltages at the same time or in a staggered order depends on whether the current zeros will occur at the same time or in a staggered order.

Each switching element may vary in configuration as long as each switching element is configured to have forward and reverse voltage blocking capabilities.

Each switching element may be a semiconductor switching element.

Each switching element may include at least one AC switching device. The AC switching device may be in the form of:

inverse-series-connected switching devices, each switching device configured to have forward voltage blocking capability;

reverse-parallel-connected switching devices, each switching device configured to have forward voltage blocking capability;

an active switching device configured to have both forward and reverse voltage blocking capabilities;

two parallel-connected sets of series-connected passive switching devices connected in parallel with an active switching device in a full-bridge arrangement.

Each switching element may include at least one first switching device connected in inverse-series with at least one second switching device, each of the first and second switching devices configured to have forward voltage blocking capability.

The or each first switching device is assembled in the same switching device stack as the or each second switching device. Alternatively the or each first switching device may be assembled in a different switching device stack from the or each second switching device.

The number of first switching devices may be different from the number of second switching devices. This allows each switching element to be configured to have asymmetrical forward and reverse voltage blocking capabilities.

When each of the first and second switching devices includes gate, collector and emitter terminals, the emitter terminal of a selected first switching device may be connected to the emitter terminal of a selected second switching device, the controller may include an auxiliary switching control unit configured to send driving signals to the gate terminals of the selected first and second switching devices or may include two auxiliary switching control units configured to send respective driving signals to the respective gate terminals of the selected first and second switching devices, and a power supply circuit may be connected across the emitter and collector terminals of the selected first or second switching device, the power supply circuit configured to supply power to drive the or each auxiliary switching control unit.

The voltage across a given switching device may be used as a source of power to drive an auxiliary switching control unit configured to send a driving signal to the gate terminal of the given switching device. However, during the normal operation of the converter of embodiments of the invention, each switching element will experience a voltage in one direction which means that, during the normal operation of the converter of embodiments of the invention, one of the selected first and second switching devices will experience a voltage thereacross that can be used as a source of power while the other of the selected first and second switching devices will not experience a voltage thereacross that can be used as a source of power.

The configuration of the selected first and second switching devices, the auxiliary switching control unit(s) and the power supply circuit permits the voltage across the one of the selected first and second switching devices to be used as a source of power to drive the auxiliary switching control unit(s) to not only send a driving signal to the gate terminal of the one of the selected first and second switching devices but send a driving signal to the gate terminal of the other of the selected first and second switching devices.

Each switching element may be configured to have asymmetrical forward and reverse voltage blocking capabilities. It may be the case that the voltage blocking requirements for the normal operation of the converter of embodiments of the invention may be different from the voltage blocking requirements for the fault operation of the converter of embodiments of the invention. Hence, configuring each switching element to have asymmetrical forward and reverse voltage blocking capabilities results in a more optimal design of each switching element.

The structure of the or each limb may vary as follows.

In embodiments of the invention, the or each phase element may include two parallel-connected sets of series-connected switching elements connected in an H-bridge, and a respective junction between each set of series-connected switching elements may define a respective AC terminal for connection to the AC network.

In further embodiments of the invention, the or each DC side sub-converter may be connected: in series with the corresponding phase element at the DC side of the corresponding phase element; in parallel with the corresponding phase element at the DC side of the corresponding phase element; or in parallel with an electrical block including the corresponding phase element at the DC side of the corresponding phase element.

In still further embodiments of the invention, the or each limb may include first and second DC side sub-converters, the or each first DC side sub-converter may be connected in series with the corresponding phase element at the DC side of the corresponding phase element, and the or each second DC side sub-converter may be connected in parallel with an electrical block including the corresponding phase element and first DC side sub-converter at the DC side of the corresponding phase element.

In such embodiments the or each limb may further include a third DC side sub-converter connected in series with the corresponding first DC side sub-converter, the or each third DC side sub-converter may be configured to be operable as a voltage synthesiser, and the or each second DC side sub-converter may be connected to a common connection point between the corresponding first and third DC side sub-converters to form a “T” arrangement.

### BRIEF DESCRIPTION OF THE DRAWINGS

Embodiments of the invention will now be described, by way of non-limiting examples, with reference to the accompanying drawings in which:

FIG. 1 schematically shows a converter according to a first embodiment;

FIGS. 2A and 2B show schematically a 4-quadrant bipolar module and a 2-quadrant unipolar module respectively;

FIG. 3 shows examples of AC switching devices;

FIGS. 4A, 4B, 5A, 5B, 6 and 7 illustrate a fault operation of the converter of FIG. 1;

FIG. 8 illustrate a free-wheeling current path that passes through the converter of FIG. 1 and the associated DC network;

FIG. 9 schematically shows a converter according to a second embodiment;

FIG. 10 illustrates the operation of the converter of FIG. 9 to absorb inductive energy stored in stray inductance;

FIG. 11 schematically shows a converter according to a third embodiment;

FIG. 12 schematically shows a converter according to a fourth embodiment;

FIG. 13 illustrates a fault operation of the converter of FIG. 12;

FIGS. 14, 15A and 15B schematically show exemplary arrangements of IGBTs to form a switching element with forward and reverse voltage blocking capabilities;

FIG. 16 illustrates a volt-time area that controls fault current; and

FIG. 17 illustrates the hard and soft current switching of the switching elements of the converter.

### DETAILED DESCRIPTION

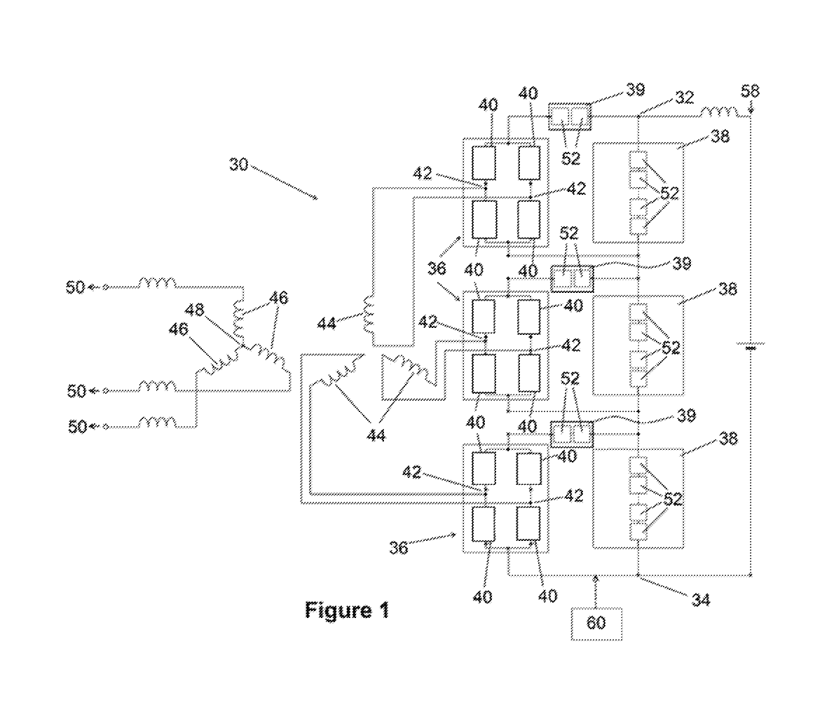

A converter according to a first embodiment of the invention is shown in FIG. 1 and is designated generally by the reference numeral 30.

The converter 30 comprises first and second DC terminals 32,34, a plurality of phase elements 36, a plurality of first DC side sub-converters 39, and a plurality of second DC side sub-converters 38.

Each phase element 36 includes two parallel-connected sets of series-connected switching elements 40 connected in an H-bridge. A respective junction between each pair of series-connected switching elements 40 defines a respective AC terminal. The AC terminals of each phase element 36 define the AC side 42 of that phase element 36.

In use, the AC terminals of each phase element 36 are interconnected by a respective one of a plurality of open secondary transformer windings 44. Each secondary transformer winding 44 is mutually coupled with a respective one of a plurality of primary transformer windings 46. The plurality of primary transformer windings 46 are connected in a star configuration in which a first end of each primary transformer winding 46 is connected to a common junction 48 and a second end of each primary transformer winding 46 is connected to a respective phase of a three-phase AC network 50. In this manner, in use, the AC side 42 of each phase element 36 is connected to a respective phase of a three-phase AC network 50.

The common junction 48 defines a neutral point of the plurality of primary transformer windings 46, and is grounded (not shown).

Each first DC side sub-converter 39 is connected in series with a respective one of the phase elements 36 at the DC side of that phase element 36 to form an electrical block including the series-connected phase element 36 and first DC side sub-converter 39. Each second DC side sub-converter 38 is connected in parallel with a respective one of the electrical blocks at the DC side of the corresponding phase element 36 to form a respective limb.

In the embodiment shown, the DC converter voltage across the first and second DC terminals 32,34 is the sum of the DC side sub-converter voltages of the second DC side sub-converters 38.

Each DC side sub-converter 38,39 includes a plurality of modules 52.

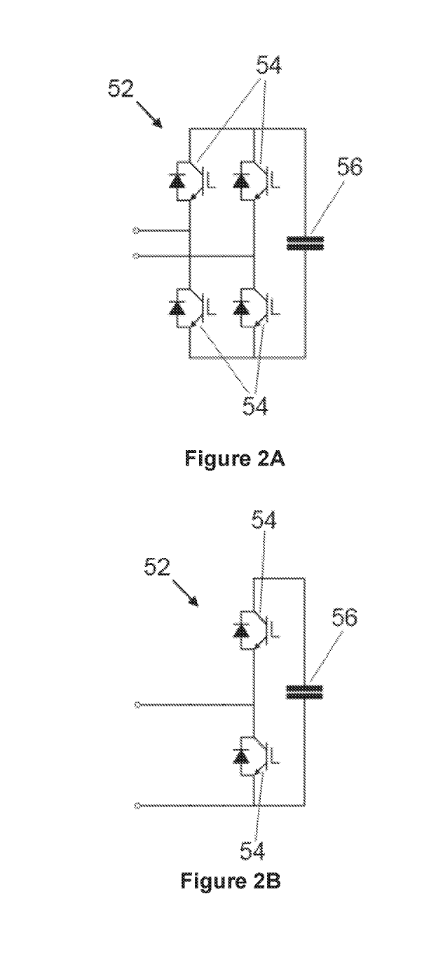

Each module 52 of each first DC side sub-converter 39 includes two pairs of module switches 54 and an energy storage device 56 in the form of a capacitor. In each first DC side sub-converter 39, the pairs of module switches 54 are connected in parallel with the capacitor 56 in a full-bridge arrangement to define a 4-quadrant bipolar module that can provide negative, zero or positive voltage and can conduct current in two directions, as shown in FIG. 2A.

Each module 52 of each second DC side sub-converter 38 includes a pair of module switches 54 and an energy storage device 56 in the form of a capacitor. In each second DC side sub-converter 38, the pair of module switches 54 is connected in parallel with the capacitor 56 in a half-bridge arrangement to define a 2-quadrant unipolar module that can provide zero or positive voltage and can conduct current in two directions, as shown in FIG. 2B.

It is envisaged that, in other embodiments of the invention, at least one module of at least one of the DC side sub-converters of the converter may be replaced by another type of module that includes a plurality of module switches and at least one energy storage device, the plurality of module switches and the or each energy storage device in the or each other type of module being arranged to be combinable to selectively provide a voltage source. For example, at least one module of the first DC side sub-converter may be replaced by a 2-quadrant unipolar module and/or at least one module of the second DC side sub-converter may be replaced by a 4-quadrant bipolar module.

It is also envisaged that, in still other embodiments of the invention, at least one of the DC side sub-converters of the converter may include a combination of different types of modules, e.g. a combination including at least one 4-quadrant bipolar module and at least one 2-quadrant unipolar module. For example, at least one of the second DC side sub-converters may include a combination including at least one 4-quadrant bipolar module and at least one 2-quadrant unipolar module.

The plurality of limbs is connected in series between the first and second DC terminals 32,34. In use, the first and second DC terminals 32,34 are respectively connected to first and second terminals of a DC network 58, the first terminal of the DC network 58 carrying a positive DC voltage, the second terminal of the DC network 58 carrying a negative DC voltage.

The configuration of each limb as set out above means that, in use, a DC side voltage appears across the parallel-connected pairs of series-connected switching elements 40 of each phase element 36, i.e. at the DC side of each phase element 36.

As such, in use, each plurality of switching elements 40 are switchable to selectively interconnect a DC side voltage at the DC side of the corresponding phase element 36 and an AC side voltage at the AC side 42 of the corresponding phase element 36. In the embodiment shown, each DC side voltage is a rectified version of the corresponding AC side voltage, e.g. a sinusoid, and vice versa, but may take other forms.

In other embodiments, it is envisaged that each phase element may include a plurality of switching elements with a different configuration to selectively interconnect the DC side voltage and the AC side voltage.

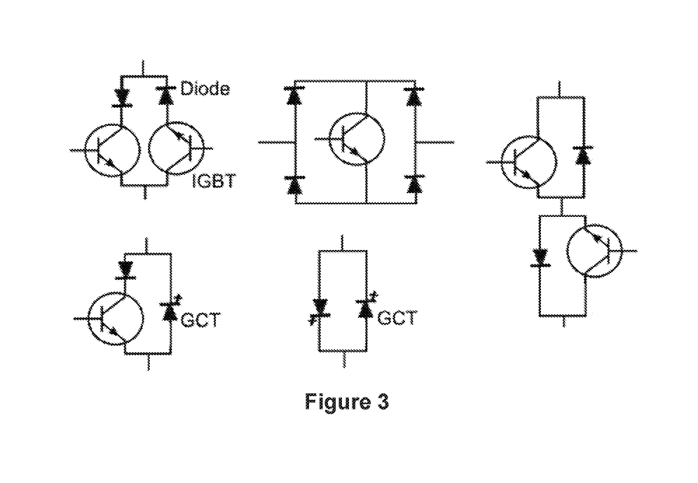

Each switching element 40 is configured to have forward and reverse voltage blocking capabilities. More specifically, each switching element 40 includes a plurality of IGBTs connected in series with a plurality of AC switching devices. Each IGBT is connected in parallel with an anti-parallel diode and is therefore configured to have forward voltage blocking capability. Each AC switching device is configured to have forward and reverse voltage blocking capabilities. Examples of an AC switching device are shown in FIG. 3 and may be in the form of:

inverse-series-connected IGBTs, where each IGBT is connected in parallel with an anti-parallel diode and is therefore configured to have forward voltage blocking capability;

reverse-parallel-connected switching devices, where each reverse-parallel-connected switching device is configured to have forward voltage blocking capability, and where each reverse-parallel-connected switching device is a gate commutated thyristor (GCT) or an IGBT connected in series with a diode;

an active switching device configured to have both forward and reverse voltage blocking capabilities;

two parallel-connected sets of series-connected diodes connected in parallel with an IGBT in a full-bridge arrangement.

For an AC switching device based on an IGBT-diode series connection, the diode may be omitted from the AC switching device if the IGBT is configured to also have reverse voltage blocking capability.

The number of IGBTs is selected to be higher than the number of AC switching devices to provide each switching element 40 with asymmetrical forward and reverse voltage blocking capabilities. In the embodiment shown, the forward voltage blocking capability of each switching element is higher than the reverse voltage blocking capability of the H-bridge. The level of forward voltage blocking capability required is determined by the voltage requirements of the normal operation described later in this specification, and the level of reverse voltage blocking capability required is determined by the voltage requirements of the fault operation described later in this specification.

Each module switch 54 constitutes an insulated gate bipolar transistor (IGBT) connected in anti-parallel with a diode.

It is envisaged that, in other embodiments of the invention, each IGBT may be replaced by a gate turn-off thyristor, a field effect transistor, an injection-enhanced gate transistor, an integrated gate commutated thyristor or any other self-commutated switching device.

It is also envisaged that, in other embodiments, each diode may be replaced by any other device that is capable of limiting current flow in only one direction.

It is further envisaged that, in other embodiments of the invention, each capacitor may be replaced by another type of energy storage device that is capable of storing and releasing energy to provide a voltage, e.g. a fuel cell or battery.

The plurality of series-connected modules 52 in each DC side sub-converter 38,39 defines a chain-link converter.

The capacitor 56 of each module 52 is selectively bypassed or inserted into the chain-link converter by changing the states of the module switches 54. This selectively directs current through the capacitor 56 or causes current to bypass the capacitor 56 so that the module 52 provides a negative, zero or positive voltage in the case of each first DC side sub-converter 39, and the module 52 provides a zero or positive voltage in the case of each second DC side sub-converter 38.

The capacitor 56 of the module 52 is bypassed when the module switches 54 in the module 52 are configured to form a short circuit in the module 52. This causes current in the chain-link converter to pass through the short circuit and bypass the capacitor 56, and so the module 52 provides a zero voltage, i.e. the module 52 is configured in a bypassed mode.

The capacitor 56 of the module 52 is inserted into the chain-link converter when the module switches 54 in the module 52 are configured to allow the current in the chain-link converter to flow into and out of the capacitor 56. The capacitor 56 then charges or discharges its stored energy so as to provide a non-zero voltage, i.e. the module 52 is configured in a non-bypassed mode.

The structure of the chain-link converter permits build-up of a combined voltage across the chain-link converter, which is higher than the voltage available from each of its individual modules 52, via the insertion of the energy storage devices 56 of multiple modules 52, each providing its own voltage, into the chain-link converter. In this manner switching of each module switch 54 in each module 52 causes the chain-link converter to provide a stepped variable voltage source, which permits the generation of a voltage waveform across the chain-link converter using a step-wise approximation. As such each chain-link converter is capable of providing a wide range of complex voltage waveforms.

The configuration of the first and second DC side sub-converters 39,38 permits their operation as voltage synthesisers respectively.

The series connection of the first DC side sub-converter 39 and the phase element 36 in each limb permits the control of the first DC side sub-converter 39 as a voltage synthesiser to modify the DC side voltage at the DC side of the corresponding phase element 36. Such modification of the DC side voltage at the DC side of the corresponding phase element 36 results in a corresponding modification of the AC side voltage at the AC side 42 of the corresponding phase element 36.

The parallel connection of the second DC side sub-converter 38 and electrical block in each limb permits the control of the second DC side sub-converter 38 as a voltage synthesiser to modify the DC converter voltage across the first and second DC terminals 32,34 that is presented to the DC network 58. Each second DC side sub-converter 38 is also operable as a voltage synthesiser to modify the DC side voltage at the DC side of the corresponding phase element 36.

The converter 30 further includes a controller 60 configured to control the switching of the switching elements 40 of the phase element 36 of each limb and configured to control the operation of each DC side sub-converter 38,39 of each limb as a voltage synthesiser.

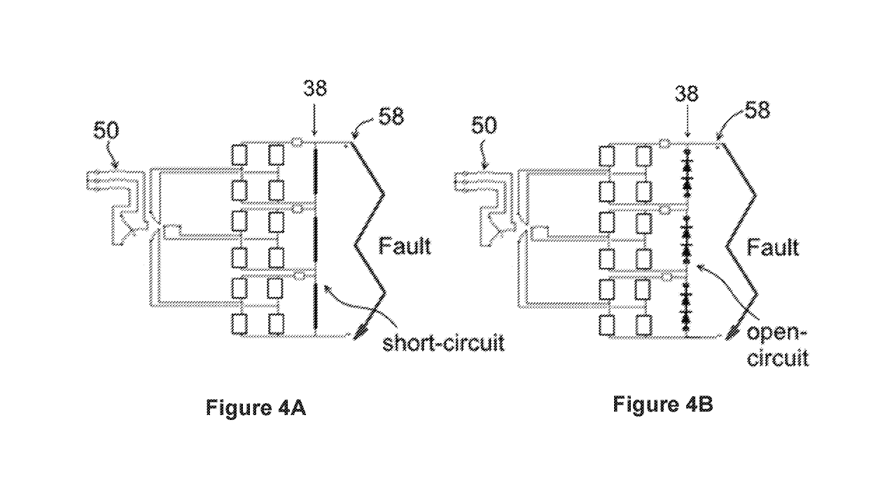

Operation of the converter 30 will now be described as follows, with reference to FIGS. 4(a) to 7.

It will be appreciated that the following numerical voltage values are merely exemplary and are chosen to illustrate the operation of the converter 30. Accordingly the following numerical voltage values may vary depending on the requirements of the converter 30 and the AC and DC networks 50,58.

During the normal operation of the converter 30, the switching elements 40 are switched on and off to interconnect the AC and DC terminals 32,34 to facilitate transfer of power between the AC and DC networks 50,58. Meanwhile the first and second DC side sub-converters 39,38 are operable as voltage synthesisers to shape the DC side voltage at the DC side of the corresponding phase element 36 in order to improve the quality of power transferred between the AC and DC networks 50,58. In addition the first DC side sub-converters 39 in the limbs are operable as voltage synthesizers to perform DC filtering in order to minimise DC ripple in the DC converter voltage across the first and second DC terminals 32,34 that is presented to the DC network 58.

In the embodiment shown, the DC converter voltage across the first and second DC terminals 32,34 is 600 kV with a voltage of +300 kV at the first DC terminal 32 and a voltage of −300 kV at the second DC terminal 34. This corresponds to an AC voltage with a peak value of +/−314 kV at the AC side 42 of each phase element 36. Therefore each switching element 40 is rated to have a forward voltage blocking capability of 314 kV, which is the sum of the forward voltage blocking capabilities of the series-connected IGBTs and AC switching devices. Each first DC side sub-converter is rated to be capable of providing a synthesised voltage with a peak value of +/−100 kV.

In the embodiment shown the reverse voltage blocking capability of each AC switching device does not play a role in the normal operation of the converter 30.

An occurrence of a short-circuit fault across the first and second DC terminals 32,34, e.g. a pole-to-pole DC fault in the DC network 58, may lead to the flow of a fault current between the AC and DC networks 50,58 and through each limb, where the flow of the fault current is driven by an AC driving voltage which is the AC voltage at the AC side 42 of each phase element 36. This is because, although the series-connected IGBTs of the switching elements 40 can be turned off, there would still be an uncontrolled flow of the fault current via the corresponding anti-parallel diodes.

As a result of the short-circuit fault across the first and second DC terminals 32,34, it is necessary for the second DC side sub-converters 38 to sum to the DC voltage at the DC network, which in the case of a solid fault is zero. At the same time it is desirable to control the modules 52 of the second DC side sub-converters 38 to prevent their capacitors 56 from discharging into the short-circuit fault.

In response to the short-circuit fault, the controller 60 controls the switching of the module switches 54 of the modules 52 of the second DC side sub-converters 38 so as to configure the modules 52 of the second DC side sub-converters 38 to form a short-circuit or open-circuit between the first and second DC terminals 32,34. FIG. 4(a) shows the formation of the short-circuit by the modules 52 of the second DC side sub-converters 38 between the first and second DC terminals 32,34 is formed by changing the states of the module switches 54 to bypass the capacitors 56 of the modules 52 of the second DC side sub-converters 38. FIG. 4(b) shows the formation of the open-circuit by the modules 52 of the second DC side sub-converters 38 between the first and second DC terminals 32,34 by changing the states of the module switches 54 to inhibit current from flowing through the modules 52 of the second DC side sub-converters 38.

The formation of the short-circuit by the modules 52 of the second DC side sub-converters 38 between the first and second DC terminals 32,34 may be formed when the short-circuit fault affects all three AC phases in a symmetrical way. In this way each AC phase can be considered to be separately experiencing a DC short-circuit by virtue of the bypassed capacitors 56 of the modules 52 of the corresponding second DC side sub-converter 38.

As shown in FIG. 5A, together with the formation of the short-circuit by the modules 52 of the second DC side sub-converters 38 between the first and second DC terminals 32,34, the controller 60 coordinates: the switching of the switching elements 40 of the phase element 36 of each limb to provide a reverse blocking voltage; and the operation of the first DC side sub-converter 39 of each limb to provide a synthesised voltage. Since the fault current in each limb flows through the first DC side sub-converter 39 and a diagonal pair of switching elements 40, the AC switching devices 43 of each switching element 40 need to provide a reverse blocking voltage with a peak value of +/−107 kV so that the diagonal pair of switching elements 40 provides a reverse blocking voltage of 214 kV that combines with the synthesised voltage of 100 kV provided by the first DC side sub-converter 39. In this manner the combination of the reverse blocking and synthesised voltages are configured to oppose the AC driving voltage with a peak of +/−314 kV at the AC side 42 of the corresponding phase element 36 so as to block the flow of the fault current.

Since the AC switching devices 43 of each switching element 40 need to be rated to provide a reverse blocking voltage with a peak value of +/−107 kV, it follows that the forward voltage blocking capability of the corresponding series-connected IGBTs 41 is set at 207 kV, as shown in FIG. 5B.

When the open-circuit is formed by the modules 52 of the second DC side sub-converters 38 between the first and second DC terminals 32,34, a common fault current flows through the limbs and the short-circuit fault. The common fault current is driven by the sum of the three-phase AC side voltages which are instantaneously at different values, as shown in FIG. 6 (which shows in detail a fault occurring at the 90 electrical degree point as an example). In this example the AC side voltages are +314 kV, −157 kV and −157 kV at the instant of the fault, and hence the common fault current is driven by a summed AC driving voltage of +/−628 kV.

As shown in FIG. 7, together with the formation of the open-circuit by the modules 52 of the second DC side sub-converters 38 between the first and second DC terminals 32,34, the controller 60 coordinates: the switching of the switching elements 40 of the phase element 36 of each limb to provide a reverse blocking voltage; and the operation of the first DC side sub-converter 39 of each limb to provide a synthesised voltage. Since the common fault current flows through the first DC side sub-converter 39 and a diagonal pair of switching elements 40 of each limb, the AC switching devices 43 of each switching element 40 need to provide a reverse blocking voltage with a peak value of approximately +/−55 kV so that the diagonal pairs of switching elements 40 provide a reverse blocking voltage of 328 kV that combines with the synthesised voltages of 300 kV provided by the first DC side sub-converters 39. In this manner the combination of the reverse blocking and synthesised voltages are configured to oppose the summed AC driving voltage with a peak of +/−628 kV so as to block the flow of the common fault current.

Since the AC switching devices 43 of each switching element 40 need to be rated to provide a reverse blocking voltage with a peak value of approximately +/−55 kV, it follows that the forward voltage blocking capability of the corresponding series-connected IGBTs is set at approximately 259 kV.

It is apparent that the formation of the open-circuit by the modules 52 of the second DC side sub-converters 38 between the first and second DC terminals 32,34 is advantageous over the formation of the short-circuit by the modules 52 of the second DC side sub-converters 38 between the first and second DC terminals 32,34 in that the required reverse voltage blocking capability for each switching element 40 in the former is lower than the required reverse voltage blocking capability for each switching element 40 in the latter.

In the embodiment shown the forward voltage blocking capability of each switching element 40 does not play a role in the fault operation of the converter 30.

The connection of the modules 52 on the DC side of the converter 30 contributes a large stray inductance, which is in addition to the large circuit inductance on the AC side 42 of the converter 30 contributed by the transformer windings 44,46 and AC network 50. Consequently, during a fault in the DC network 58, the fault current can rise to a high level before the controller 60 is able to respond to the fault by coordinating: the switching of the switching elements 40 of the phase element 36 of each limb to provide the reverse blocking voltage; and the operation of the first DC side sub-converter 39 of each limb to provide the synthesised voltage.

Each switching element 40 may be configured to include an energy absorption or dissipation device, such as a metal oxide varistor, which can be employed to absorb or dissipate the inductive energy stored in the AC side inductance. Additionally the controller 60 may control the switching of the module switches 54 of the modules 52 of the first DC side sub-converters 39 to selectively insert the corresponding capacitors into the converter 30 as to absorb inductive energy stored in the stray inductance.

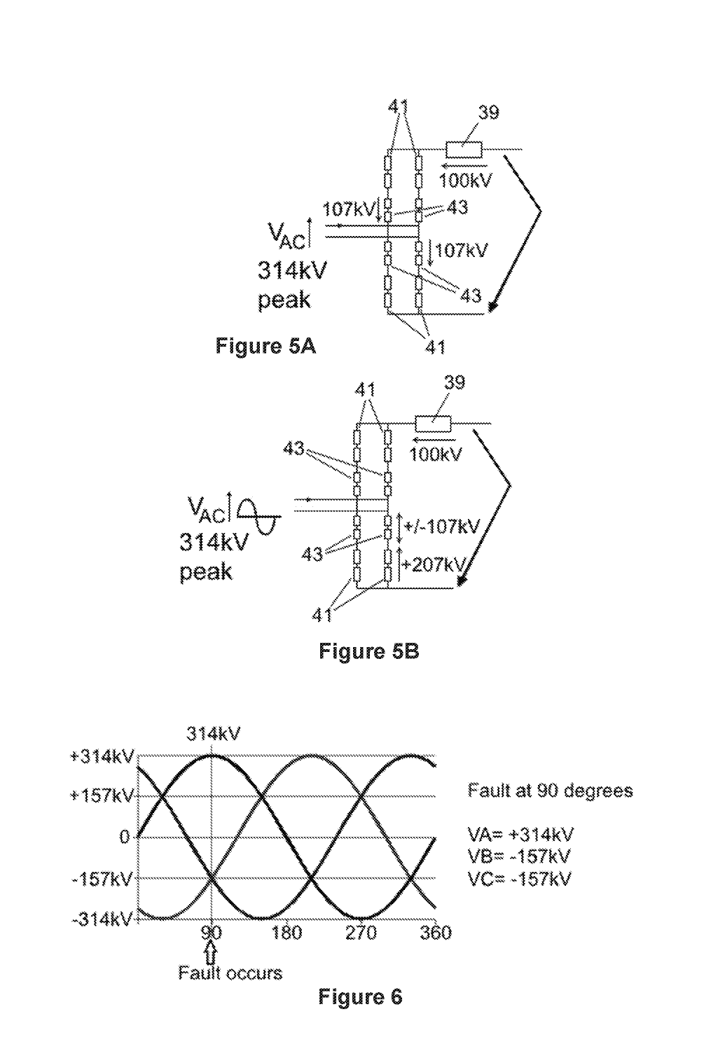

However, as shown in FIG. 8, a further free-wheeling current path 45 through the anti-parallel diodes of the modules 52 of the second DC side sub-converters 38 and the DC network 58 may be present when the fault occurs, where the further free-wheeling current path does not include any components to absorb or dissipate inductive energy stored in the stray inductance 47.

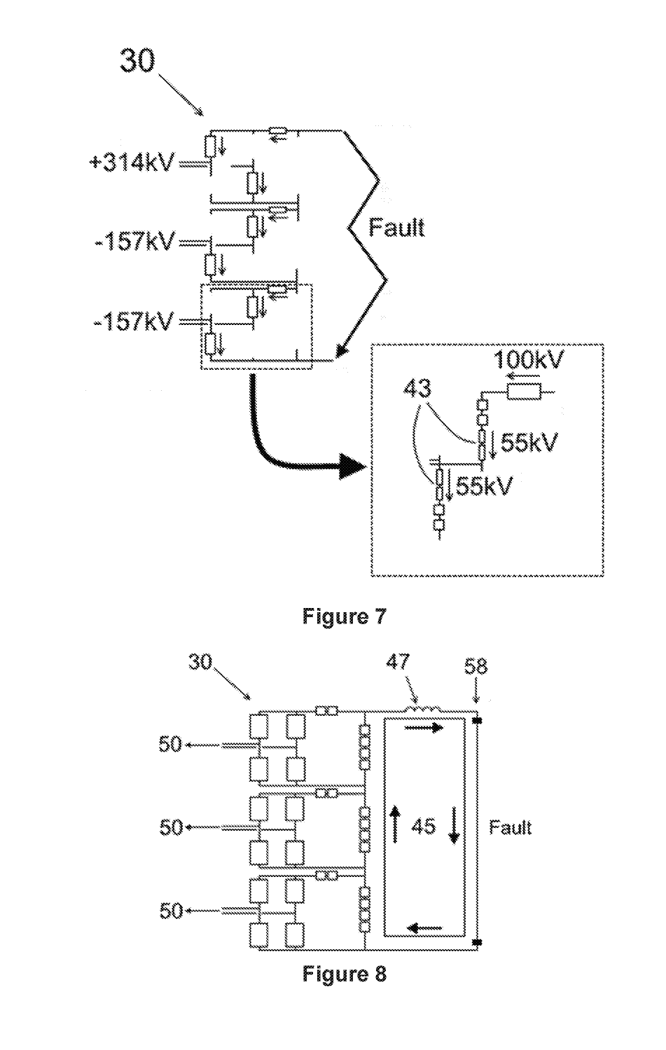

A converter according to a second embodiment of the invention is shown in FIG. 9 and is designated generally by the reference numeral 130. The converter 130 of FIG. 9 is similar in structure and operation to the converter 30 of FIG. 1, and like features share the same reference numerals.

The converter 130 of FIG. 9 differs from the converter 30 of FIG. 1 in that each limb of the converter 130 of FIG. 9 further includes a respective third DC side sub-converter 62.

In each limb, the third DC side sub-converter 62 is connected in series with the corresponding first DC side sub-converter 39, with the corresponding second DC side sub-converter 38 being connected to a common connection point between the corresponding first and third DC side sub-converters 39,62 to form a “T” arrangement.

Each module 52 of each third DC side sub-converter 62 includes two pairs of module switches 54 and an energy storage device 56 in the form of a capacitor. In each third DC side sub-converter 62, the pairs of module switches 54 are connected in parallel with the capacitor 56 in a full-bridge arrangement to define a 4-quadrant bipolar module that can provide negative, zero or positive voltage and can conduct current in two directions, as shown in FIG. 2A.

Each third DC side sub-converter 62 is structurally and operationally configured as a chain-link converter in the same manner as each first sub-converter 39 described above with reference to the converter 30 of FIG. 1. Thus, each third DC side sub-converter 62 is configured to be operable to act as a voltage synthesiser.

In the embodiment shown, the DC converter voltage across the first and second DC terminals 32,34 is the sum of the DC side sub-converter voltages of the second and third DC side sub-converters 38,62.

The connection of the third DC side sub-converter 62 in each limb permits the operation of the third DC side sub-converter 62 as a voltage synthesiser to modify the DC converter voltage across the first and second DC terminals 32,34 that is presented to the DC network 58.

During the normal operation of the converter 30, the third DC side sub-converters 62 in the limbs are operable as voltage synthesizers to perform DC filtering in order to minimise DC ripple in the DC converter voltage across the first and second DC terminals 32,34 that is presented to the DC network 58.

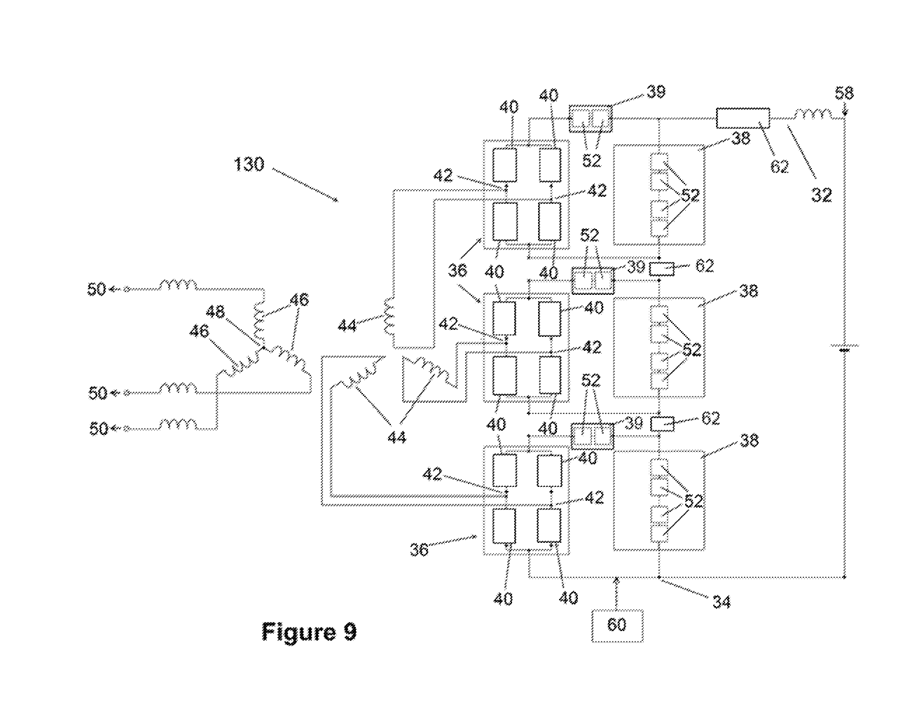

During the fault operation of the converter 30, the controller 60 controls the switching of the module switches 54 of the modules 52 of the first and third DC side sub-converters 39,62 to selectively insert the corresponding capacitors 56 into the converter 130 and therefore into the free-wheeling current path so as to absorb inductive energy stored in the stray inductance. This is shown in FIG. 10. Absorption of the inductive energy in this manner speeds up the decay time of a current 57 arising from the stored inductive energy.

In other embodiments of the invention, it is envisaged that each second DC side sub-converter may include at least one 4-quadrant bipolar module in addition to its 2-quadrant unipolar modules, so that the controller may control the switching of the module switches of the 4-quadrant bipolar modules of the second DC side sub-converters to selectively insert the corresponding capacitors into the converter as to absorb inductive energy stored in the stray inductance.

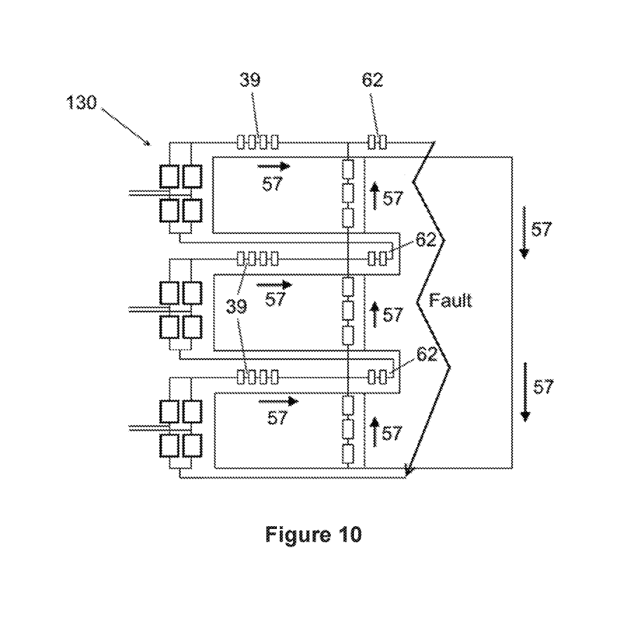

A converter according to a third embodiment of the invention is shown in FIG. 11 and is designated generally by the reference numeral 230. The converter 230 of FIG. 11 is similar in structure and operation to the converter 130 of FIG. 9, and like features share the same reference numerals.

The converter 230 of FIG. 11 differs from the converter 130 of FIG. 9 in that only one of the limbs of the converter 230 of FIG. 11 further includes a third DC side sub-converter 62 connected in series with the corresponding first DC side sub-converter 39, with the corresponding second DC side sub-converter 38 being connected to a common connection point between the corresponding first and third DC side sub-converters to form a “T” arrangement.

In the embodiment shown, the limbs are arranged in series so that the third DC side sub-converter is connected directly to the first DC terminal 32. This means that the DC converter voltage across the first and second DC terminals 32,34 is the sum of the DC side sub-converter voltages of the second DC side sub-converters 38 and the third DC side sub-converter 62.

It is envisaged that, in other embodiments of the invention, the third DC side sub-converter 62 may be connected directly to the second DC terminal 34, instead of the first DC terminal 32.

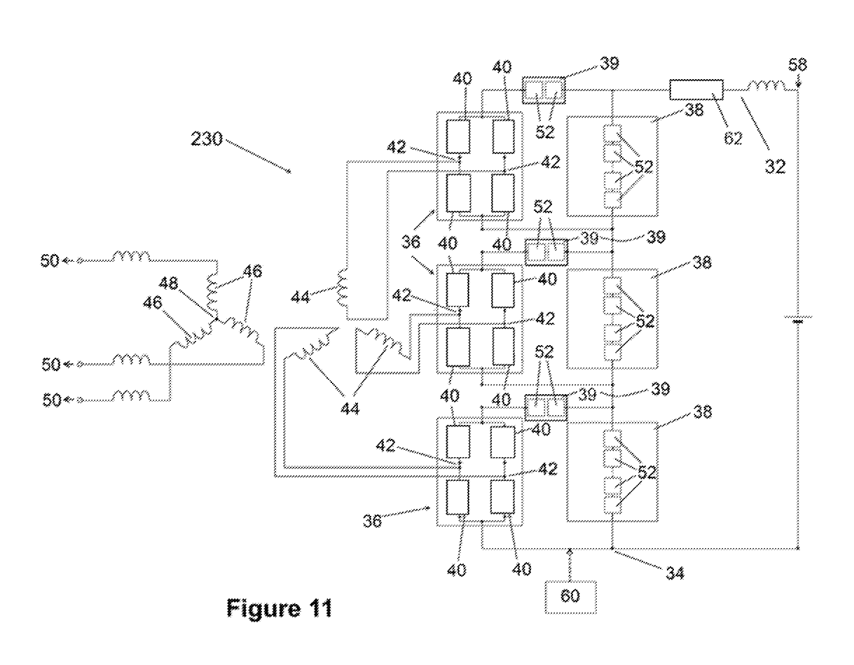

A converter according to a fourth embodiment of the invention is shown in FIG. 12 and is designated generally by the reference numeral 330. The converter 330 of FIG. 12 is similar in structure and operation to the converter 30 of FIG. 1, and like features share the same reference numerals.

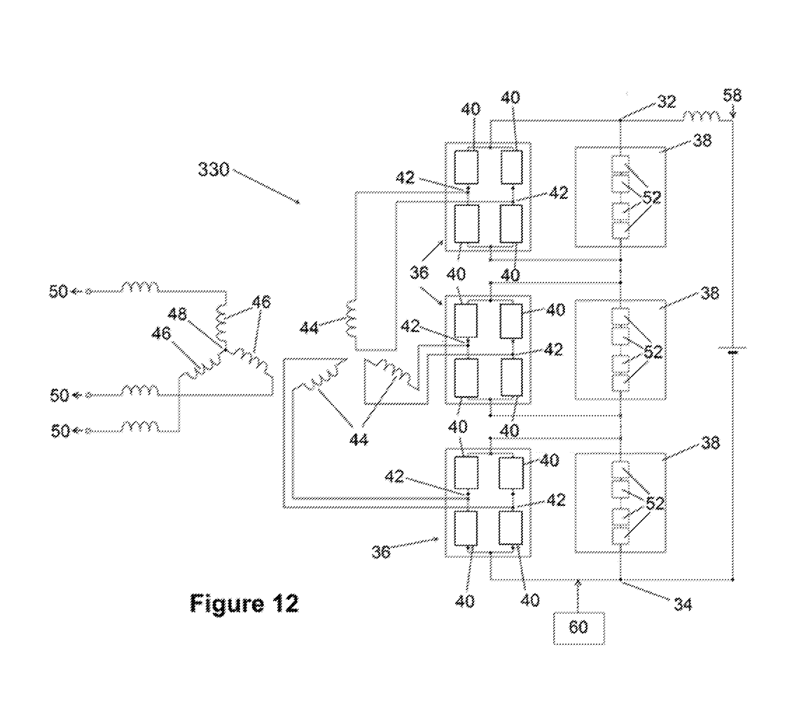

The converter 330 of FIG. 12 differs from the converter 30 of FIG. 1 in that each limb of the converter 330 of FIG. 12 omits the respective first DC side sub-converter 39. As shown in FIG. 13, the controller 60 controls the switching of the switching elements 40 to provide the reverse blocking voltages to oppose the summed AC driving voltage with a peak of +/−628 kV so as to block the flow of the common fault current. In this instance each switching element 40 provides a blocking voltage of +/−105 kV.

Further optional features of embodiments of the invention are described as follows.

In embodiments of the invention, each switching element 40 may be configured in different ways to have forward and reverse voltage blocking capabilities.

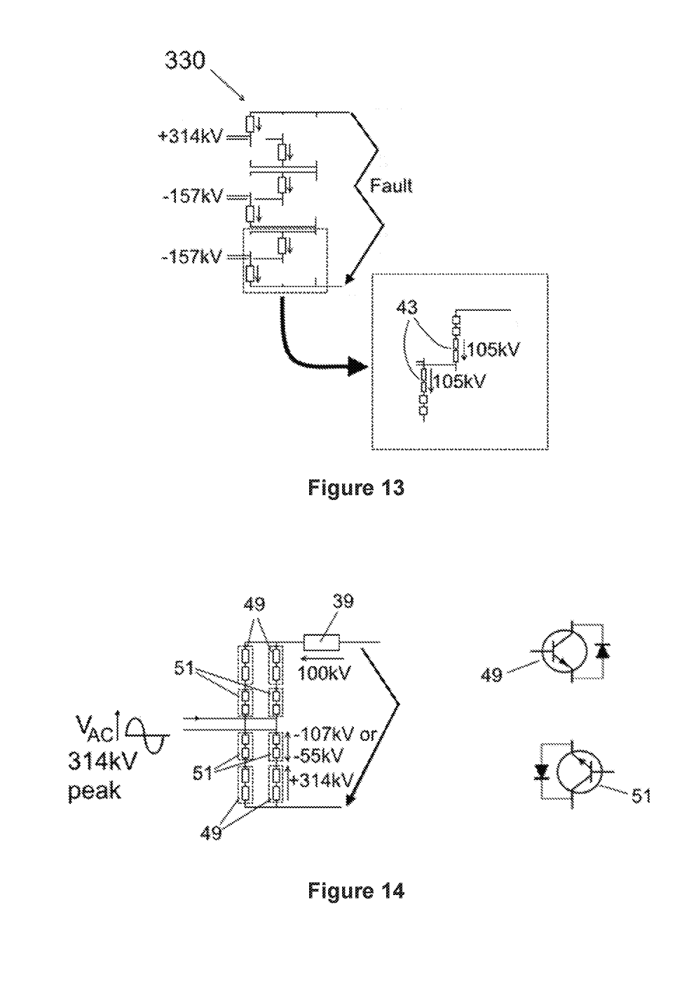

For example, each switching element 40 may include a plurality of first IGBTs 49 connected in inverse-series with a plurality of second IGBTs 51 so as to provide the switching element 40 with forward and reverse voltage blocking capabilities, as shown in FIG. 14. Each of the first and second IGBTs 49, 51 is connected in parallel with an anti-parallel diode.

The number of first IGBTs 49 is selected to be higher than the number of second IGBTs 51 to provide each switching element 40 with asymmetrical forward and reverse voltage blocking capabilities. In the embodiment shown, the forward voltage blocking capability of each switching element 40 is higher than the reverse voltage blocking capability of that switching element 40.

Using the earlier-mentioned numerical voltage values as examples, the plurality of first IGBTs 49 in each limb are required to provide the corresponding switching element 40 with a forward voltage blocking capability of +314 kV, while the plurality of second IGBTs 51 in each limb are required to provide the corresponding switching element 40 with a reverse voltage blocking capability of −107 kV with reference to FIGS. 5A and 5B or approximately −55 kV with reference to FIG. 7.

Each first IGBT 49 may be assembled in a different IGBT stack from each second IGBT 51, where the different IGBT stacks are connected in inverse-series. This is illustrated in FIG. 14.

Alternatively each first IGBT 49 may be assembled in the same IGBT stack as each second IGBT 51, where the first IGBTs 49 are connected in inverse-series with the second IGBTs 51 within the same IGBT stack. This forms an asymmetric IGBT stack, as shown in FIG. 15A. For example, an 8 IGBT stack could comprise 6 forward-connected IGBTs 49 and 2 reverse-connected IGBTs 51, and would have a forward voltage blocking capability of 12 kV and a reverse voltage blocking capability of −4 kV.

The voltage across a given IGBT may be used as a source of power to drive an auxiliary switching control unit configured to send a driving signal to the gate terminal of the given IGBT. However, during the normal operation of the converter of embodiments of the invention, each switching element 40 will experience a forward voltage which means that, during the normal operation of the converter of embodiments of the invention, the selected first IGBT will experience a voltage thereacross that can be used as a source of power while the selected second IGBT will not experience a voltage thereacross that can be used as a source of power.

As shown in FIG. 15B, in an embodiment of the invention where each first IGBT 49 is assembled in the same IGBT stack as each second IGBT 51, the emitter terminal of a selected first IGBT 49 may be connected to the emitter terminal of a selected second IGBT 51, the controller 60 includes an auxiliary switching control unit 53 configured to send driving signals to the gate terminals of the selected first and second IGBTs 49, 51, and a power supply circuit 55 is connected across the emitter and collector terminals of the selected first IGBT 49, the power supply circuit 55 configured to supply power to drive the auxiliary switching control unit 53. Alternatively the controller 60 may include two separate auxiliary switching control units (not shown) configured to send respective driving signals to the respective gate terminals of the selected first and second IGBTs, and the power supply circuit is configured to supply power to drive both auxiliary switching control units.

This permits the voltage across the selected first IGBT 49 to be used as a source of power to drive the auxiliary switching control unit(s) 53 to send driving signals to the gate terminals of both of the selected first and second IGBTs 49, 51.

Normally an IGBT is operated at about 60% of its maximum forward voltage blocking capability to ensure that FIT (failure in time) rates are met. For example, a 4.5 kV IGBT would practically be operated at a forward voltage of about 2.8 kV in normal operation. However, since each switching element 40 will experience a forward voltage during normal operation of the converter, the reverse-connected second IGBTs will be shorted out by their anti-parallel diodes during normal operation of the converter and thereby only transiently experience voltage stress during a fault in the DC network 58.

As such the second IGBTs can be operated much nearer to their peak voltage blocking capability (e.g. 3.5 kV-4.0 kV) during the single-shot fault operation and still achieve the required FIT rates. In practice both the forward-connected first IGBTs and reverse-connected second IGBTs will be protected by an appropriate Surge Protection Device (SPD) which will be designed to provide a final level of safe over-voltage protection of both the forward-connected first IGBTs and reverse-connected second IGBTs. Transient operation at this higher operating voltage means the number of reverse-connected IGBTs may be reduced, thus minimising converter losses and footprint.

In the above embodiments, the fault current is controlled by the AC driving voltage(s) applied across the AC circuit inductance that comprises the transformer leakage reactance and the impedance contributed by the AC network 50. In practice, it is the volt-time area applied to the AC circuit inductance that drives the peak value and shape of the fault current peak. The current rises to a high value but would naturally fall to zero and then reverse if no action were to be taken to block the reverse connected IGBTs contained within the switching elements 40.

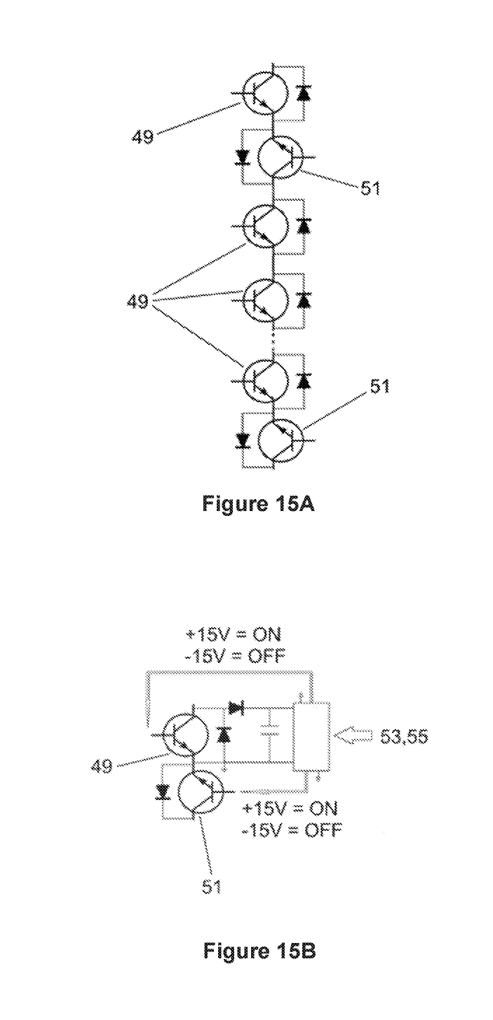

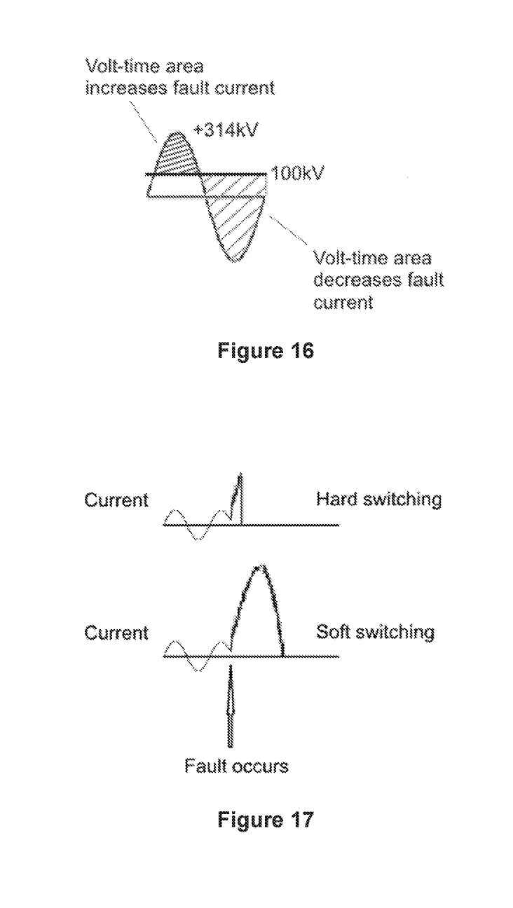

FIG. 16 illustrates the volt-time area that controls the fault current, while FIG. 17 illustrates the hard and soft current switching of the switching elements of the converter of embodiments of the invention.

It can be seen that the current drops to zero quickly within 1 power cycle following the occurrence of the fault. Here the 100 kV synthesised voltage provided by the first DC side sub-converter significantly increases the negative volt-time area driving the current back towards zero after it has reached its peak value and would normally ensure a natural current zero occurs in the second half cycle (i.e. within 20 ms on a 50 Hz AC network) following the occurrence of the fault.

Once the fault current has reached a predetermined over-current level at which the switching elements 40 can safely switch, the controller 60 controls the hard or soft current switching of the switching elements 40 to provide the blocking voltages, as shown in FIG. 17.

The choice of the switching elements 40 undergoing hard or soft current switching when providing the blocking voltages depends on the design of the switching elements 40.

Hard switching the switching elements at a high over-current level permits a faster response time for providing the blocking voltage and thereby reduces the time to reach a current zero. The hard current switching however results in a high rate of change in current and thereby produces inductive energy, which may require the switching elements to include components capable of absorbing or dissipating the inductive energy.

On the other hand soft switching the switching elements at a lower over-current level not only reduces the amount of inductive energy produced, but also results in a lower rate of change in current and thereby reduces the associated voltage transient, thus reducing the requirements to absorb or dissipate the inductive energy. The soft current switching however results in a slower response time for providing the blocking voltage due to the need to wait till near the end of the power cycle, and thereby increases the time to reach a current zero.

When the above hard or soft current switching strategy is applied to the fault operation in which the short-circuit is formed by the modules 52 of the second DC side sub-converters 38 between the first and second DC terminals 32,34 (as shown in FIG. 4(a)), the current zeros will occur at different times with respect to the different AC phases such that the respective blocking voltages are provided in a staggered order.

When the above hard or soft current switching strategy is applied to the fault operation in which the open-circuit is formed by the modules 52 of the second DC side sub-converters 38 between the first and second DC terminals 32,34 (as shown in FIG. 4(b)), the flow of a common fault current in the different AC phases means that the current zeros will occur at the same time with respect to the different AC phases such that the respective blocking voltages are provided at the same time.

It is envisaged that, in other embodiments of the invention, the configuration of each DC side sub-converter may vary as long as each DC side sub-converter is capable of being operable as a voltage synthesiser.

In the embodiments shown, the AC side of each phase element is connected to a respective phase of a three-phase AC network. It is envisaged that, in other embodiments, the number of limbs in the converter may vary with the number of phases of a multi-phase AC network, and the AC side of each phase element may be connected to a respective phase of the multi-phase AC network.

It is also envisaged that, in still other embodiments, the converter may include a single limb, and the AC side of the phase element may be connected to the single-phase AC network.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A converter comprising first and second DC terminals for connection to a DC network, the converter further including at least one limb connected between the first and second DC terminals, the or each limb including:
a phase element having a plurality of switching elements and at least one AC terminal for connection to an AC network the plurality of switching elements configured to be switchable to selectively interconnect a DC side voltage at a DC side of the phase element and an AC side voltage at an AC side of the phase element, each switching element of the phase element configured to have forward and reverse voltage blocking capabilities; and
at least one DC side sub-converter connected to the DC side of the phase element, the or each DC side sub-converter configured to be operable as a voltage synthesiser,
wherein the converter further includes a controller configured to selectively control the switching of the switching elements of the phase element of the or each limb and configured to selectively control the operation of the or each DC side sub-converter of the or each limb as a voltage synthesiser, and
wherein the controller is configured to control the switching of the switching elements of the phase element of the or each limb to provide a blocking voltage to limit or block the flow of a fault current between the AC and DC networks and through the or each limb.

2. The converter according to claim 1, wherein the or each blocking voltage is configured to oppose an AC driving voltage at the AC side of the or each phase element so as to limit or block the flow of the fault current between the AC and DC networks and through the or each limb.

3. The converter according to claim 1, wherein the controller is configured to coordinate: the switching of the switching elements of the phase element of the or each limb to provide a blocking voltage; and the operation of the DC side sub-converter or at least one of the DC side sub-converters of the or each limb to provide a synthesised voltage, so that the combination of the blocking and synthesised voltages are configured to limit or block the flow of a fault current between the AC and DC networks and through the or each limb.

4. The converter according to claim 3, wherein the combination of the blocking and synthesised voltages are configured to oppose an AC driving voltage at the AC side of the or each phase element so as to limit or block the flow of the fault current between the AC and DC networks and through the or each limb.

5. The converter according to claim 1, wherein the or each DC side sub-converter includes at least one module, the or each module includes a plurality of module switches connected with at least one energy storage device, and the plurality of module switches and the or each energy storage device in the or each module are arranged to be combinable to selectively provide a voltage source.

6. The converter according to claim 5, wherein the or each DC side sub-converter includes a plurality of series-connected modules arranged to define a chain-link converter.

7. The converter according to claim 1, wherein the or each DC side sub-converter of the or each limb includes at least one module connected between the first and second DC terminals, the or each module includes a plurality of module switches connected with at least one energy storage device, the plurality of module switches and the or each energy storage device in the or each module are arranged to be combinable to selectively provide a voltage source, and the controller is configured to control the switching of the module switches of the or each module connected between the first and second DC terminals so as to configure the or each module connected between the first and second DC terminals to form a short-circuit or open-circuit between the first and second DC terminals.

8. The converter according to claim 5, wherein the controller is configured to control the switching of the module switches of the or each module to selectively insert the or each corresponding energy storage device into the converter so as to absorb inductive energy stored in DC side inductance on the DC side of the or each phase element.

9. The converter according to claim 1, wherein the controller is configured to control the hard or soft current switching of the switching elements of the or each phase element to provide the blocking voltage.

10. The converter according to claim 1, including a plurality of limbs, the phase element of each limb being connectable via the or each corresponding AC terminal to a respective phase of a multi-phase AC network.

11. The converter according to claim 10, wherein the plurality of limbs are connected in series between the first and second DC terminals.

12. The converter according to claim 10 wherein the controller is configured to control the switching of the switching elements of the phase elements to provide the respective blocking voltages at the same time or in a staggered order.

13. The converter according to claim 1, wherein each switching element is a semiconductor switching element.

14. The converter according to claim 1, wherein each switching element includes at least one AC switching device.

15. The converter according to claim 14, wherein the AC switching device is in the form of:
inverse-series-connected switching devices, each switching device configured to have forward voltage blocking capability;
reverse-parallel-connected switching devices, each switching device configured to have forward voltage blocking capability;
an active switching device configured to have both forward and reverse voltage blocking capabilities;
two parallel-connected sets of series-connected passive switching devices connected in parallel with an active switching device in a full-bridge arrangement.

16. The converter according to claim 1, wherein each switching element includes at least one first switching device connected in inverse-series with at least one second switching device, each of the first and second switching devices configured to have forward voltage blocking capability.

17. The converter according to claim 16, wherein: the or each first switching device is assembled in the same switching device stack as the or each second switching device; or the or each first switching device is assembled in a different switching device stack from the or each second switching device.

18. The converter according to claim 16, wherein the number of first switching devices is different from the number of second switching devices.

19. The converter according to claim 16 wherein each of the first and second switching devices includes gate, collector and emitter terminals, the emitter terminal of a selected first switching device is connected to the emitter terminal of a selected second switching device, the controller includes an auxiliary switching control unit configured to send driving signals to the gate terminals of the selected first and second switching devices or includes two auxiliary switching control units configured to send respective driving signals to the respective gate terminals of the selected first and second switching devices, and a power supply circuit is connected across the emitter and collector terminals of the selected first or second switching device, the power supply circuit configured to supply power to drive the or each auxiliary switching control unit.

20. The converter according to claim 1, wherein each switching element is configured to have asymmetrical forward and reverse voltage blocking capabilities.

21. The converter according to claim 1, wherein the or each phase element includes two parallel-connected sets of series-connected switching elements connected in an H-bridge, and a respective junction between each set of series-connected switching elements defines a respective AC terminal for connection to the AC network.

22. The converter according to claim 1, wherein the or each DC side sub-converter is connected: in series with the corresponding phase element at the DC side of the corresponding phase element; in parallel with the corresponding phase element at the DC side of the corresponding phase element; or in parallel with an electrical block including the corresponding phase element at the DC side of the corresponding phase element.

23. The converter according to claim 1, wherein the or each limb includes first and second DC side sub-converters, the or each first DC side sub-converter is connected in series with the corresponding phase element at the DC side of the corresponding phase element, and the or each second DC side sub-converter is connected in parallel with an electrical block including the corresponding phase element and first DC side sub-converter at the DC side of the corresponding phase element.

24. The converter according to claim 23, wherein the or each limb further includes a third DC side sub-converter connected in series with the corresponding first DC side sub-converter, the or each third DC side sub-converter is configured to be operable as a voltage synthesiser, and the or each second DC side sub-converter is connected to a common connection point between the corresponding first and third DC side sub-converters to form a “T” arrangement.
